(19) United States
(12) Patent Application Publication
(10) Pub. No.: US 2007/0122520 A1
(43) Pub. Date: May 31, 2007

(54) CLAMPING DEVICE

(75) Inventor: Yang-Chang Chien, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/460,600

(22) Filed: Jul. 27, 2006

(30) Foreign Application Priority Data
Nov. 25, 2005 (TW) 94141514

(51) Int. Cl. B29C 45/64; B29C 45/00

(52) U.S. Cl. 425/589; 425/808; 425/595

(57) ABSTRACT

A clamping device for clamping a lens preform includes a base, at least two clamping portions, and a driving device. Each of the clamping portions defines a recess at a top thereof. Each pair of adjacent recesses cooperatively form a space when the two adjacent clamping portions are in contact with each other. The clamping portions are reciprocally moveable on a bottom of the base between a holding position and a releasing position. The driving device is configured for driving the clamping portions to move between the holding position and the releasing position. The clamping portions are moved towards each other to reach the holding position in a manner such that the lens preform is held by the clamping portions. The clamping portions are moved towards each other to reach the releasing position in a manner such that the lens preform is released from the clamping portions.

### 1. FIELD OF THE INVENTION

The present invention relates to clamping devices, and more particularly to a clamping device for clamping a lens preform.

### 2. DESCRIPTION OF RELATED ART

Nowadays, plastic lenses are widely used in consumer electronics products, for example, digital cameras, as they are cheap and simple to produce.

A method for producing plastic lenses generally includes the following steps: forming a lens preform using an injection molding apparatus; and cutting the lens preform and obtaining a number of lenses. Referring to FIG. 10, a lens preform 10 is shown. The lens preform 10 includes four lenses 12, a sprue forming portion 14, and four runner forming portions 16. The lenses 12 are each connected to the sprue forming portion 14 by the runner forming portions 16. The lenses 12 can be cut away from the runner forming portions 16.

In the cutting process, a clamping device is provided to hold the lens preform 10. Referring to FIG. 11, a typical clamping device 22 is shown. The clamping device 22 includes two grooves 221 and 222 at the top thereof. The lens preform 10 is carried to the space above the clamping device 22 and dropped to the clamping device 22 in such a manner that the runner portions 16 are engaged in the grooves 221 and 222. Then the cutting takes place.

However, it is difficult to drop the lens preform 10 into the clamping device 22 precisely. That is, the runner portions 16 may not easily engage in the grooves 221 and 222. In this case, the lenses 12 cannot be properly cut from the lens preform 10.

It is therefore desirable to find a new clamping device which can overcome the above mentioned problems.

### SUMMARY OF THE INVENTION

In a preferred embodiment, a clamping device for clamping a lens preform includes a base, at least two clamping portions, and a driving device. The base includes a flat bottom. The clamping portions are arranged on the bottom. Each of the clamping portions defines a recess at a top thereof. Each pair of adjacent recesses cooperatively form a space when the two adjacent clamping portions are in contact with each other. The clamping portions are reciprocally moveable on the bottom between a holding position and a releasing position. The driving device is configured for driving the clamping portions to move between the holding position and the releasing position. The clamping portions are moved towards each other to reach the holding position in a manner such that the lens preform is held by the clamping portions. The clamping portions are moved towards each other to reach the releasing position in a manner such that the lens preform is released from the clamping portions.

Other advantages and novel features will become more apparent from the following detailed description of the present clamping device, when taken in conjunction with the accompanying drawings.

### BRIEF DESCRIPTION OF THE DRAWINGS

Many aspects of the clamping device can be better understood with reference to the following drawings. The components in the drawings are not necessarily drawn to scale, the emphasis instead being placed upon clearly illustrating the principles of the present invention.

FIG. 1 is a schematic isometric view of a clamping device in accordance with a first embodiment;

FIG. 2 is a schematic top view of a base of the clamping device of FIG. 1;

FIG. 3 is a cross-sectional view of the clamping device of FIG. 1, showing clamping portions thereof are in a clamping position;

FIG. 4 is a cross-sectional view of the clamping device of FIG. 1, showing clamping portions thereof are in a releasing position;

FIG. 5 is a schematic isometric view of the clamping device of FIG. 1, together with a lens preform clamped therein;

FIG. 6 is a cross-sectional view of the clamping device and the lens perform of FIG. 5;

FIG. 7 is a cross-sectional view of the clamping device of FIG. 1, showing a lens preform is dropped into the clamping device;

FIG. 8 is a schematic isometric view of a clamping device, in accordance with a second embodiment;

FIG. 9 is a schematic isometric view of a clamping device of FIG. 8, together with a lens preform clamped therein;

FIG. 10 is a schematic isometric view of a typical lens perform;

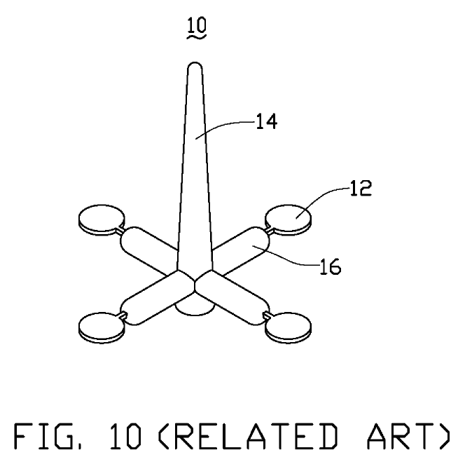

FIG. 11 is a schematic isometric view of a typical clamping device together with the lens perform clamped therein.

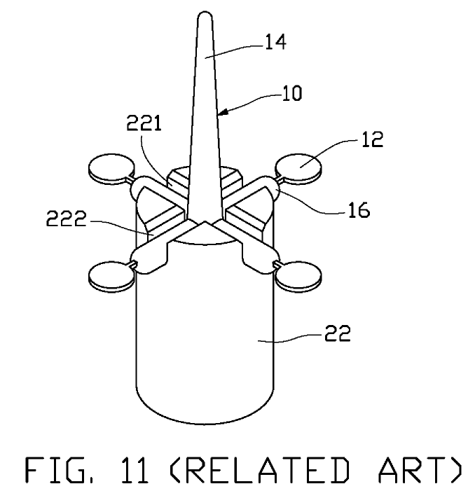

Corresponding reference characters indicate corresponding parts throughout the drawing. The exemplifications set out herein illustrate at least one preferred embodiment of the invention, in one form, and such exemplifications are not to be construed as limiting the scope of the invention in any manner.

### DETAILED DESCRIPTION OF THE INVENTION

Reference will now be made to the drawings to describe the preferred embodiments of the present clamping device in detail.

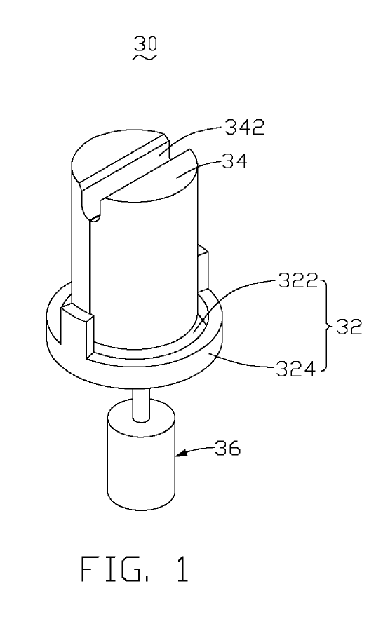

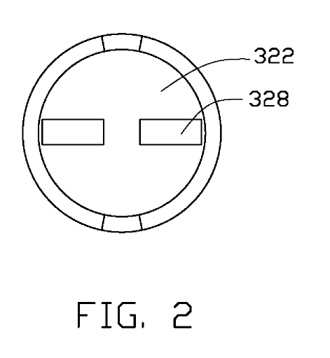

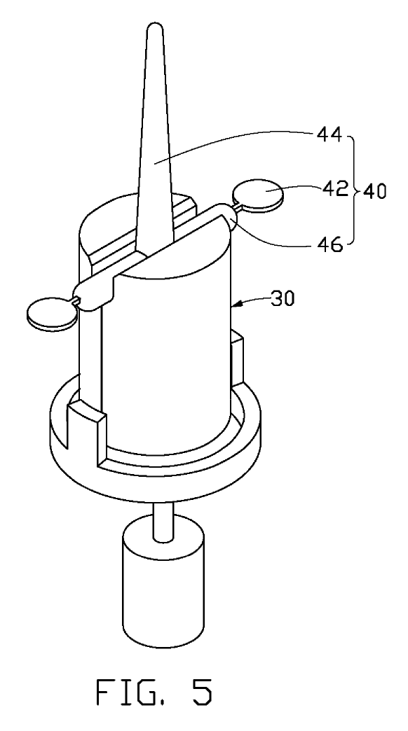

Referring to FIGS. 1 and 2, a clamping device 30 for clamping a lens preform 40 (referring to FIG. 5) is shown in accordance with a first embodiment. The clamping device 30 includes a base 32, two clamping portions 34 and a driving device 36.

The base 32 includes a flat circular bottom 322 and a peripheral side wall 324 extending from the bottom 322. The bottom 322 defines two slots 328 therein. The slots 328 are oriented radially. The side wall 324 is for further confining the clamping portions 34 to the base when the clamping portions 34 move outwards.

The clamping portions 34 are arranged within the base 32 on the bottom 322. Each clamping portion 34 is a half-cylinder with a recess defined therein at a top thereof. The recesses cooperatively form a space 342 when the clamping portions 34 are in contact with each other. The clamping portions 34 are reciprocally movable on the bottom 322 between a holding position and a releasing position. The clamping portions 34 are moved towards each other to reach the holding position in a manner such that the lens preform 40 is held by the clamping portions 34. The clamping portions 34 are moved towards each other to reach the releasing position in a manner such that the lens preform 40 is released from the clamping portions 34.

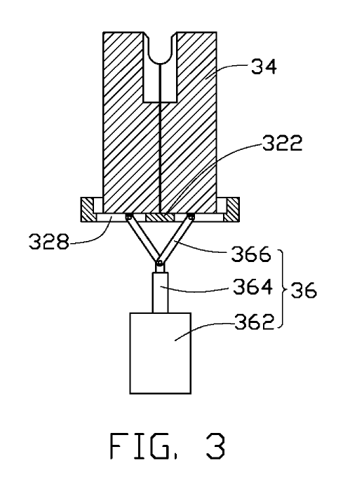

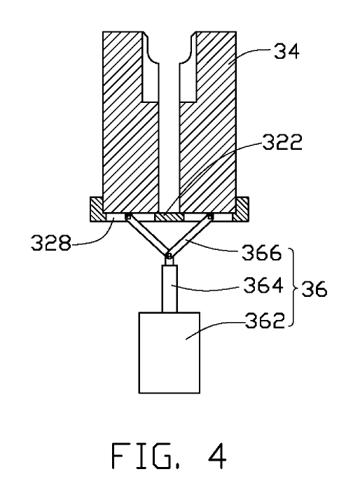

Referring to FIGS. 3 and 4, the driving device 36 includes a driving element 362, a shaft 364, and two rods 366. The shaft 364 has one end connected with the driving element 362 and the other end connected to the two rods 366. Each rod 366 has one end coupled to a bottom of each clamping portion 34 and the other end hinged with the other end of the shaft 364. The rods 366 extend through and are slidable in the slots 328 on the bottom 322. The driving element 362 is, for example, a pneumatic cylinder, or a hydraulic cylinder. The driving element 362 drives the shaft 364 to move lengthwise, the rods 366 then drive the clamping portions 34 to move between the holding position and the releasing position. When the shaft 364 is driven by the driving element 362 to move downward, the rods 366 drive the clamping portions 34 to move towards each other to clamp the lens preform 40 (referring to FIG. 5); when the shaft 364 is driven by the driving element 362 to move upward, the rods 366 drive the clamping portions 34 to move away from each other to release the lens preform 40.

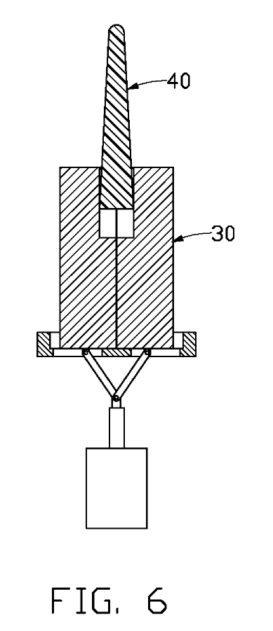

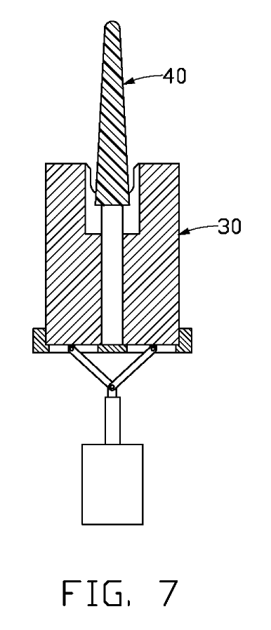

Referring to FIGS. 5 to 7, the lens preform 40 includes two lenses 42, a sprue forming portion 44, and two runner forming portions 46. The lenses 42 are connected to the sprue forming portion 44 by the runner forming portions 46. The lens preform 40 is held by the clamping device 30 in the cutting process. The operation of the clamping device 30 includes the steps of:
driving the clamping portions 34 to move away from each other;
dropping the lens preform 40 into the clamping device 30;
driving the clamping portions 34 to move towards each other to clamp the lens preform 40 firmly; and
cutting the lens 42 from the lens preform 40.

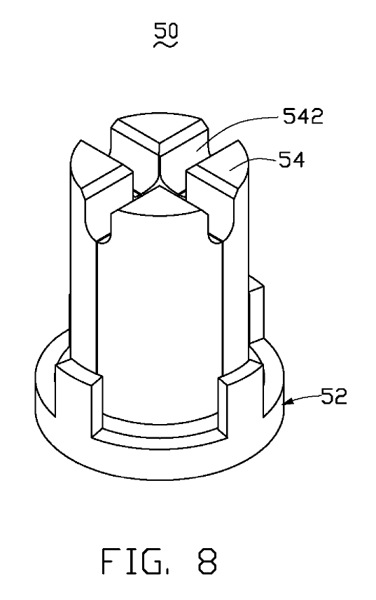

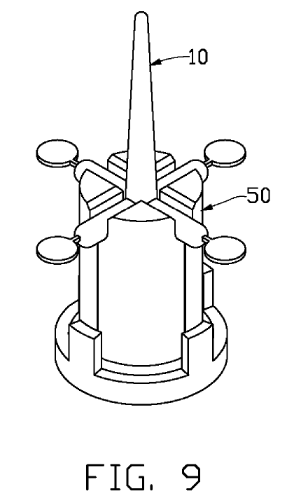

Referring to FIGS. 8 and 9, a clamping device 50 for clamping the lens preform 10 is shown in accordance with a second embodiment. The clamping device 50 includes a base 52, four clamping portions 54 and a driving device (not shown) similar to the driving device 36 of the clamping device shown in FIG. 1. The clamping device 50 is similar to the clamping device 30, but includes four clamping portions 54. Each clamping portion 54 is a quarter-cylinder with a recess defined therein at a top thereof. Each pair of adjacent recesses cooperatively form a space 542 when the two adjacent clamping portions are in contact with each other. The driving device drives the clamping portions 54 to move towards each other to clamp the lens preform 10 and to move away from each other to release the lens preform 10.

The operation of the clamping device is similar to that of the clamping device 30.

It should be noted that the clamping device can have at least two clamping portions depending on the lens preform to be cut. Each clamping portion can be a part cylinder.

Although the present invention has been described with reference to specific embodiments, it should be noted that the described embodiments are not necessarily exclusive, and that various changes and modifications may be made to the described embodiments without departing from the scope of the invention as defined by the appended claims.

What is claimed is:

1. A clamping device for clamping a lens preform, comprising:
a base comprising a flat bottom;
at least two clamping portions arranged on the bottom, each of the clamping portions defining a recess at a top thereof, each pair of adjacent recesses thereby cooperatively forming a space when the two adjacent clamping portions are in contact with each other, wherein the clamping portions are reciprocally moveable on the bottom between a holding position where the clamping portions are moved towards each other in a manner such that the lens preform is held by the clamping portions, and a releasing position where the clamping portions are moved away from each other such that the lens preform is released from the clamping portions; and
a driving device configured for driving the clamping portions to move between the holding position and the releasing position.

2. The clamping device as recited in claim 1, wherein each clamping portion is a half cylinder.

3. The clamping device as recited in claim 1, wherein the driving device comprises a driving element, a shaft, and at least two rods, the shaft having one end connected with the driving element, the at least two rods each having one end coupled to a bottom of the respective clamping portion and the other end hinged with the other end of the shaft.

4. The clamping device as recited in claim 3, wherein the driving element is selected from the group consisting of a pneumatic cylinder and a hydraulic cylinder.

5. The clamping device as recited in claim 1, wherein the base further comprises a peripheral side wall extending from the flat bottom.

6. A device for clamping a lens preform, comprising:
a base;
a plurality of clamping members arranged on the base, the clamping portions being reciprocally moveable on the base between a holding position where the clamping portions are moved towards each other in a manner such that the lens preform is held by the clamping portions, and a releasing position where the clamping portions are moved away from each other such that the lens preform is released from the clamping portions; and
a driving device configured for driving the clamping portions to move between the holding position and the releasing position, the driving device comprising a plurality of rods, a shaft, and a driving member configured for driving the shaft to move lengthwise, each of the rods having a first end coupled to the respective clamping member and an opposite second end coupled to the shaft.

7. The device as recited in claim 6, wherein the base defines a plurality of slots, the rods extending through and slidable in the respective slots.

8. The device as recited in claim 6, wherein the slots are oriented radially.

9. The device as recited in claim 6, wherein each two adjacent clamping portions cooperatively defines a space configured for retainably receiving a portion of the lens preform therein at a top thereof, when the two adjacent clamping portions are in the holding position.
